(19) United States
(12) Patent Application Publication
(10) Pub. No.: US 2007/0143961 A1
(43) Pub. Date: Jun. 28, 2007

(54) Shutter mounting hinge

(75) Inventor: Bruce A. Weber, Summerville, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: The Muhler Company, Inc., North Charleston, SC (US)

(21) Appl. No.: 11/315,078

(22) Filed: Dec. 22, 2005

(51) Int. Cl. E05D 7/10

(52) U.S. Cl. 16/265

(57) ABSTRACT

A hinge assembly for mounting a shutter onto a vertical wall comprises two or more pintel hinges, each comprising a pintel having an upper end and a lower end, where the lower end is affixed to a base for attachment to the wall; one or more right-hand L-hinge; and one or more left-hand L-hinge, wherein each L-hinge comprises a socket to mate with a pintel to form a hinged connection and a strap for attachment to the shutter. Methods for making and using the hinge assembly are also described.

### BACKGROUND OF THE INVENTION

(1) Field of the Invention

The present invention relates to a hinge, and more particularly to a hinge designed for the mounting of a shutter on a vertical wall or the like.

(2) Description of the Related Art

Shutters are useful to protect openings in the exterior walls of buildings, such as windows and doors, from harm during severe weather. They are often also useful for decorative purposes. The use of raised panel shutters, Bahamas shutters, or louvered shutters on exterior walls of homes and buildings for the protection and decoration of windows is well known and examples of these and other shutters are described in U.S. Pat. Nos. 3,394,518, 3,455,079, 3,797,186, 4,248,022, 4,251,966, 4,610,289, 4,765,110, 4,858,400, 5,060,442, 5,152,116, 5,255,486, 5,347,782, 5,379,551, 5,603,190, 5,653,057, 5,778,958, 5,848,505, and 6,901,701, among others. These shutters can be functional—they can be opened and closed to cover or uncover a window, door, or other opening, or they can merely be decorative and mounted to the exterior wall of the structure in a fixed open position.

When the shutters are functional, they are usually mounted to the wall of the building at the side of the window or door to be protected in a location where they can be opened to uncover the window or door, or shut to cover the opening. The mountings that are used to attach the shutter to the wall of the structure usually comprise a hinge of some sort that enables the shutter to be changed from the open position to the closed position. Often, two shutters are employed, with one mounted on each side of the opening. In this case, the shutters close over the opening and are latched together.

Functional shutters are an important part of the exterior of the building. They must be sufficiently rugged and durable to withstand normal, and even severe, effects of weathering—in particular, protection of the window or door from storm damage. The overall construction of the shutter itself is usually of wood, wood clad with metal or plastic, or of plastic.

Shutters commonly must be repainted, repaired, or otherwise maintained in order to retain suitable appearance and to maintain functional integrity. Because it is usually easier to carry out such tasks when the shutter is detached from the building, it is important that the shutter be easy to remove and replace from its mountings. In some hinge designs, such as shown in U.S. Pat. No. 1,341,690, the pintel is fixed in place at both top and bottom. Disassembly, therefore, requires proper tools and significant time.

Wall penetrations by mounting hardware (mounting screws and the like) are a common sources of water intrusion into walls, which over time can cause serious structural damage, therefore it is important that a weather-tight seal is established between the mounting hinge and the structural wall. Examples of hinges that require some sort of unsealed wall penetration are described in U.S. Pat. Nos. 144,898, 440,320, 442,093, 537,697, 778,144, 1,170,106, 3,349,428, 3,349,429, 4,882,809, and 5,001,863.

Hinges that are used to mount doors and shutters are usually constructed of metal in order to provide the strength necessary to support the weight of the door or shutter and to withstand the impact of severe weather. Metals are usually subject to damage due to weathering, usually by corrosion, and metal hinges are often the first part of a shutter system that requires maintenance or that fails during hard use. Furthermore, if two different metals are used in the construction of the hinge or the mounting, then galvanic corrosion can accelerate the corrosion process.

Moreover, in many mounting systems that utilize two hinges per shutter, only one of the hinges—commonly the lower hinge—provides vertical support for the shutter. The entire weight of the shutter, therefore, is bourn by only one of the two hinges. Examples of hinge systems of this sort are shown in U.S. Pat. No. 3,662,493,

Therefore, although the construction of doors and shutters and mounting systems for them have been improved significantly due to the availability of new materials and new designs, it would be useful to provide shutter mounting hardware that provided for easy installation and removal of the shutter, yet provided high strength to withstand wind load and rough usage. It would also be useful if such mounting hardware provided resistance to environmental corrosion and to galvanic corrosion. It would also be useful if such hardware provided vertical support of the door or shutter from every hinge to distribute weight evenly and maximize strength. It would also be useful if such mounting hardware provided cushioning against impact, as by blowing around in the wind, and also if it provided an effective seal between the hinge and the building wall to prevent moisture penetration into the wall and corrosion of back of hinge.

### SUMMARY OF THE INVENTION

Briefly, therefore, the present invention is directed to a novel hinge assembly for mounting a shutter onto a vertical wall, the assembly comprising: two or more pintel hinges, each comprising a pintel having an upper end and a lower end, where the lower end is affixed to a base for attachment to the wall; one or more right-hand L-hinge; and one or more left-hand L-hinge, wherein each L-hinge comprises a socket to mate with a pintel to form a hinged connection and a strap for attachment to the shutter, and wherein the strap of each right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section, and wherein each left-hand L-hinge is a mirror image of each of the right-hand L-hinges.

The present invention is also directed to a novel method of producing a hinge assembly for mounting a shutter on a vertical wall, the method comprising: forming two or more pintel hinges, each comprising a pintel having an upper end and a lower end, where the lower end is affixed to a base for attachment to the wall; forming one or more right-hand L-hinge; and forming one or more left-hand L-hinge, wherein each L-hinge comprises a socket to mate with a pintel to form a hinged connection and a strap for attachment to the shutter, and wherein the strap of each right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section, and wherein each left-hand L-hinge is a mirror image of the right-hand L-hinge.

The present invention is also directed to a novel method of mounting a shutter on a vertical wall, the method comprising: providing a shutter having a front and a back, two side rails and a panel at each end; providing a hinge assembly comprising two or more pintel hinges each comprising a pintel having a lower end and an upper end, where the lower end is affixed to a base for attachment to the wall; one or more right-hand L-hinge; and one or more left-hand L-hinge, wherein each L-hinge comprises a socket to mate with a pintel to form a hinged connection and a strap for attachment to the shutter, and wherein the strap of the right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section and optionally offset from the plane of the strap, and wherein each left-hand L-hinge is a mirror image of the right-hand L-hinge; attaching each L-hinge to the shutter so that the first section of each strap lies along the front of a separate end panel, the second section of each strap lies along the front of the same side rail, and the third section of each strap and the socket extend past the side of the rail, where at least two L-hinges are located with their respective first sections closer to the ends of the shutter and the respective second sections closer to the center of the shutter and if the center axis of the socket of one L-hinge is offset from the plane of the shutter, the center axis of the sockets of all L-hinges are offset toward the same side of the shutter; mating the socket of each L-hinge with the pintel of a pintel hinge; and attaching the base of each pintel hinge to the wall.

Among the several advantages found to be achieved by the present invention, therefore, may be noted the provision of a door or shutter mounting hinge assembly that provides for easy installation and removal of the shutter, yet provides high strength to withstand wind load and rough usage, and also the provision of such a mounting hinge that also provides resistance to environmental corrosion and to galvanic corrosion, and also the provision of such a mounting hinge that provides vertical support of the door or shutter by every hinge so that the weight of the door or shutter is divided evenly between the hinges so that strength is maximized, and also the provision of such a mounting hinge that provides cushioning against impact, as by blowing around in the wind, and also the provision of such a mounting hinge that provides an effective seal between the hinge and the building wall to prevent moisture penetration into the wall and corrosion of back of hinge.

### BRIEF DESCRIPTION OF THE DRAWINGS

FIG. 1 illustrates an embodiment of the hinge assembly of the present invention where the left-hand and right-hand L-hinges are attached to a louvered shutter and two pintel hinges are attached to a vertical wall, where arrows indicate the movement necessary to mate the sockets of the L-hinges with the pintels of the pintel hinges to form a hinged connection between the wall and the shutter and thereby to mount the shutter on the wall;

FIG. 2 shows three views of an embodiment of a pintel hinge of the present invention having a shorter horizontal arm, where (A) is a front elevation view, (B) is a right side elevation view, (C) is a top elevation view, and (D) illustrates an optional resilient washer that slips over the pintel to cushion the contact between the boss of a pintel hinge and the socket of an L-hinge, and where “S” indicates the distance between the center axis of the pintel and the flat surface of the base of the pintel hinge;

FIG. 3 shows three views of an embodiment of a pintel hinge of the present invention having a longer horizontal arm, where (A) is a front elevation view, (B) is a right side elevation view, (C) is a top elevation view, and (D) illustrates an optional resilient washer that slips over the pintel to cushion the contact between the boss of a pintel hinge and the socket of an L-hinge, and where “S” indicates the distance between the center axis of the pintel and the flat surface of the base of the pintel hinge;

FIG. 4 illustrates an embodiment of (A) a pintel of the present hinge assembly having a split-ring groove near its top, and (B) examples of a snap ring and a hairpin clip for seating in the split-ring groove of the pintel, and illustrating a cross-sectional view of a hairpin clip installed in the groove of the pintel;

FIG. 5 illustrates front elevation views of two embodiments of a resilient base gasket of the present invention where the gasket in (A) is solid, and the gasket in (B) has a cut-out that roughly matches the optional hollow section in the base plate of a pintel hinge;

FIG. 6 illustrates several views of an embodiment of a right-hand L-hinge of the present hinge assembly, where (A) shows a front elevation view, (B) and (B′) show top elevation views of a right-hand L-hinge having different degrees of offset of the center axis of the socket, and (C) shows a rear elevation view, and (D) shows an optional resilient bushing that fits inside the socket of the L-hinge to cushion and protect the pintel when the socket and the pintel are mated;

FIG. 7 illustrates several views of an embodiment of a left-hand L-hinge of the present hinge assembly, where (A) shows a front elevation view, (B) and (B′) show top elevation views of a left-hand L-hinge having different degrees of offset of the center axis of the socket, and (C) shows a rear elevation view, and (D) shows an optional resilient bushing that fits inside the socket of the L-hinge to cushion and protect the pintel when the socket and the pintel are mated;

FIG. 8 illustrates front and side views of a pair of L-hinges of an embodiment of the present invention, where (A) is the top elevation view of a right-hand L-hinge and (B) is a right side elevation view of that hinge; (C) is the top elevation view of a left-hand L-hinge, and (D) is a right side elevation view of that hinge;

FIG. 9, FIG. 10, and FIG. 11 illustrate selected views of three embodiments of an L-hinge of the present invention, where the (A) views show a partial front view of a right-hand L-hinge attached to the top right corner of a shutter, and the (B) views show perspective views of pairs of right-hand and left-hand L-hinges of each embodiment;

FIG. 12 is a partial top view that illustrates an embodiment of the mounting of the present hinge assembly where a pintel hinge having a longer horizontal arm is used and the L-hinges are positioned with the flat side facing outward when the shutter is opened;

FIG. 13 is a partial top view that illustrates an embodiment of the mounting of the present hinge assembly where a pintel hinge having a shorter horizontal arm is used and the L-hinges are positioned with the flat side facing outward when the shutter is opened; and

FIG. 14 is a partial top view that illustrates an embodiment of the mounting of the present hinge assembly where a pintel hinge having a shorter horizontal arm is used and the L-hinges are positioned with the flat side facing outward when the shutter is closed.

Corresponding reference characters indicate corresponding parts throughout the several views of the drawings.

### DETAILED DESCRIPTION OF THE PREFERRED EMBODIMENTS

In accordance with the present invention, it has been discovered that a novel hinge assembly can be provided for mounting a shutter or a door, or the like, onto a vertical wall. The present hinge assembly includes two or more pintel hinges, which can be identical, with each having a pintel that has an upper end and a lower end, where the lower end is affixed to a base. Commonly, the base has a flat surface that is formed for attachment to the wall. The hinge assembly also includes one or more right-hand L-hinge and one or more left-hand L-hinge. In a common embodiment, two pintel hinges can be used along with one right-hand L-hinge and one left-hand L-hinge. However, three, four, or even more pairs of pintel and L-hinges can be used.

Each L-hinge comprises a socket to mate with a pintel to form a hinged connection and a strap for attachment to the shutter. The strap of each right-hand L-hinge has a first section that is joined at one end to an end of a second section at a right angle. The second section is joined to a third section that extends at a right angle from the second section in a direction opposite the first section. The end of the third section that is not connected to the second section is connected to a socket so that the center axis of the socket is parallel to the longitudinal axis of the second section. In other words, if the second section of the L-hinge strap is attached to a side rail of a typical shutter so that the longitudinal axis of the second section is aligned with the longitudinal axis of the side rail (the longer dimensions of each run in the same direction). And each of the left-hand L-hinge of the assemblies is a mirror image of the right-hand L-hinge.

These four parts form the novel hinge assembly and provide it with several advantages. For example, the angular attachment of the first section and the second section of the strap of the L-hinge permit simultaneous attachment of the hinge to both a vertical rail and a horizontal panel of a shutter—thereby giving better support to the components of the shutter, while giving a secure attachment of the shutter to the hinge.

In one embodiment, the pintels are made from 18/8 stainless steel and the L-hinge and pintel hinge bases are made from high-tensile LM5 cast aluminum alloy. The combination of the 18/8 stainless steel and the LM5 aluminum alloy provides resistance to environmental corrosion, has high metal/metal compatibility (and low galvanic corrosion), and gives high strength to all of the individual components of the hinge assembly.

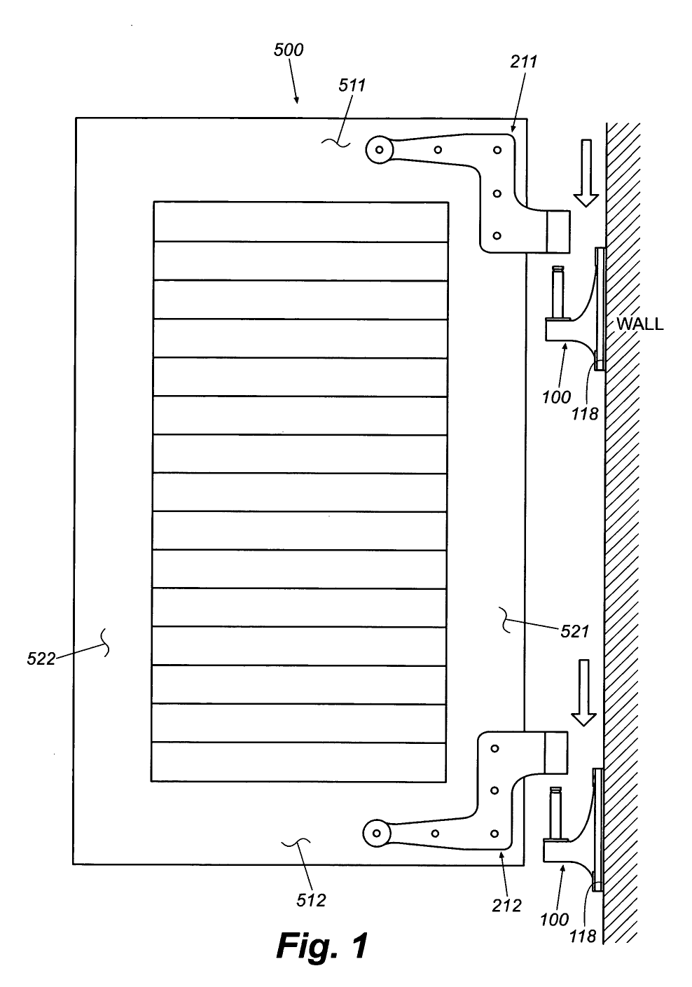

It is also preferred to provide the pintel with a peripheral snap-ring groove to mate with a snap ring or a hairpin clip. The groove is formed into the pintel at a location that is above the level of the socket of an L-hinge when the L-hinge is mated with the pintel hinge. Attachment of the snap ring or the hairpin clip into the groove on the pintel then retains the shutter against vertical movement, as may be caused by high wind load, while allowing support of the weight of the shutter by both hinges. In other words, the weight-bearing surface of both pintel hinges can be used to carry the weight of the shutter, while still retaining the shutter on the wall during storms, for example. Removal of the snap ring or hairpin clips allows quick and easy removal of the shutter from the mounting hinges simply by lifting the shutter so that the sockets of the L-hinges clear the pintels. Re-installation is just as quick and easy, and simply requires sliding the sockets of the L-hinges down over the pintels and installing the snap rings or hairpin clips. In FIG. 1, arrows show the direction of movement of the shutter as it is being mounted.

In another embodiment the present hinge assembly includes a neoprene rubber base gasket that fits between the base of the pintel hinge and the wall. This gasket gives the pintel hinge enough cushioning effect that it protects the hinge against damage due to impact on the shutter, as in banging in a wind, and it also provides a weather-tight seal between the base of the pintel hinge and the wall, thereby protecting the mounting surface of the hinge and the wall penetrations from moisture encroachment and damage.

The components of the present hinge assembly can be described with reference to the accompanying figures. FIG. 1 illustrates how the hinge assembly can be used to mount a shutter (500) onto a vertical wall. Here, the shutter (500) has two vertical side rails (521 and 522), and two end-panels (511 and 512). The shutter can also be described as having a front and a back. Commonly, the front of the shutter is the surface that faces outward when the shutter is open, and the back of the shutter is the surface that faces outward when the shutter is closed. Because the present hinge assembly can be used with almost any type of shutter, panel, or door, the interior panels of the shutter can be made of any material or may be missing entirely. Typically, the hinge assembly is used to mount raised panel shutters and louvered shutters, and a louvered shutter is depicted as an example in FIG. 1.

In FIG. 1 a right-hand L-hinge (211) is mounted to one of the side rails (521) and the top panel (511) of the shutter and a left-hand L-hinge (212) is mounted to the same side rail (521) and to the bottom panel (512). The L-hinges can be attached to the side rail and end panels by any method of attachment, including, for example, screws, nuts and bolts, gluing, or welding. However, the use of screws is preferred.

This figure also illustrates how a shutter with two L-hinges attached can be mated with two pintel hinges (100) that are mounted to a wall. The pintel hinges are spaced so that the sockets of the two L-hinges mate with the pintels of the pintel hinges. Optionally, a resilient gasket (180) can be placed between the base of a pintel hinge (100) and the wall.

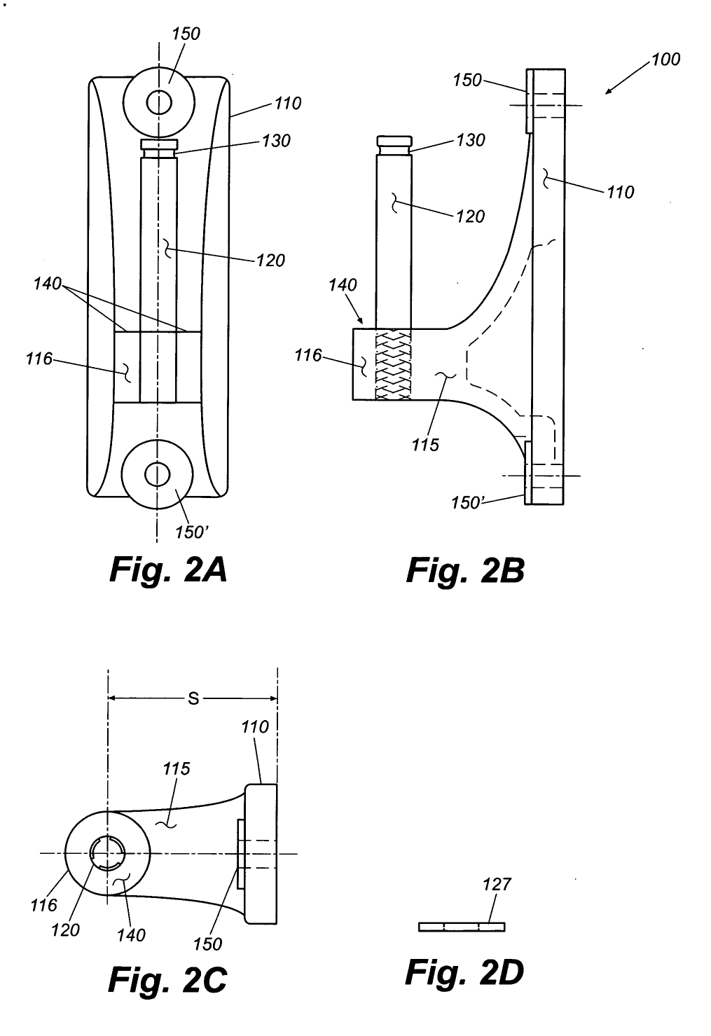

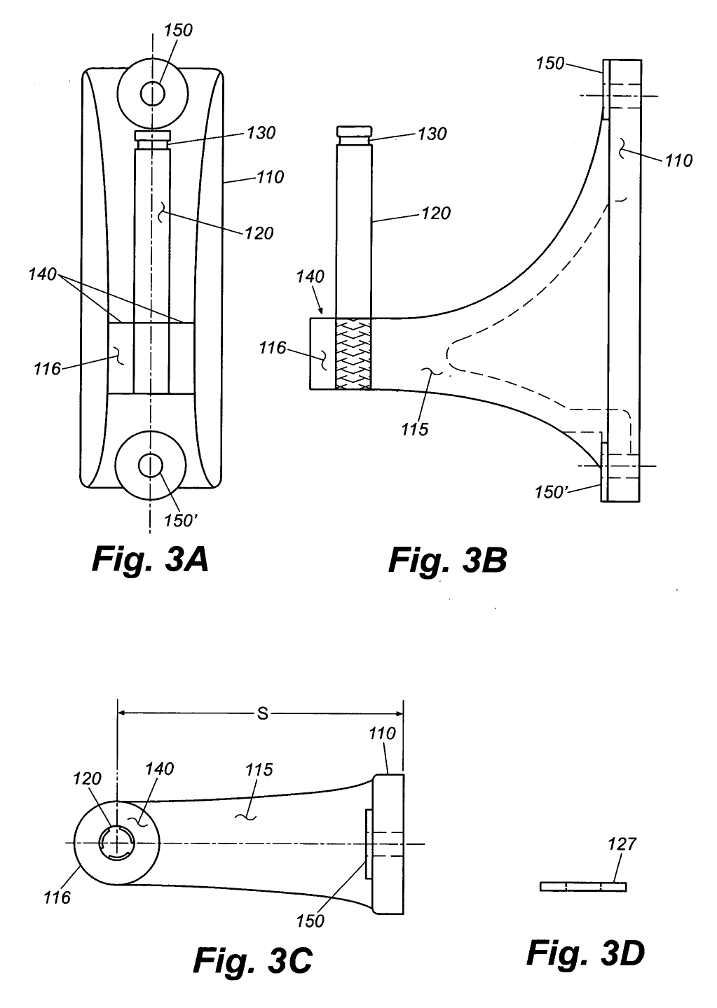

The present hinge assembly includes two or more pintel hinges. Examples of pintel hinges of the present invention are shown in FIGS. 2A-2C and FIGS. 3A-3C, and can be described with reference to these figures. Each pintel hinge (100) includes a pintel (120) having an upper end and a lower end, where the lower end of the pintel is affixed to a base. The base comprises a plate (110) having a flat surface to mate with the wall and an arm (115) extending from the plate (110) opposite the flat surface and ending in a boss (116) into which the lower end of the pintel (120) is mounted so that the pintel is spaced away from the plate (110) and is vertical when the plate is attached to the wall. In other words, it is preferred that the free end of each pintel is pointed upward when the base is attached to the wall. The boss (116) of the pintel hinge has a horizontal weight bearing surface (140) at the mounted end (the lower end) of the pintel (120) to support the socket of an L-hinge (211 or 212), which, when mated with the pintel, forms a hinged attachment between the pintel hinge (100) and the L-hinge (211 or 212).

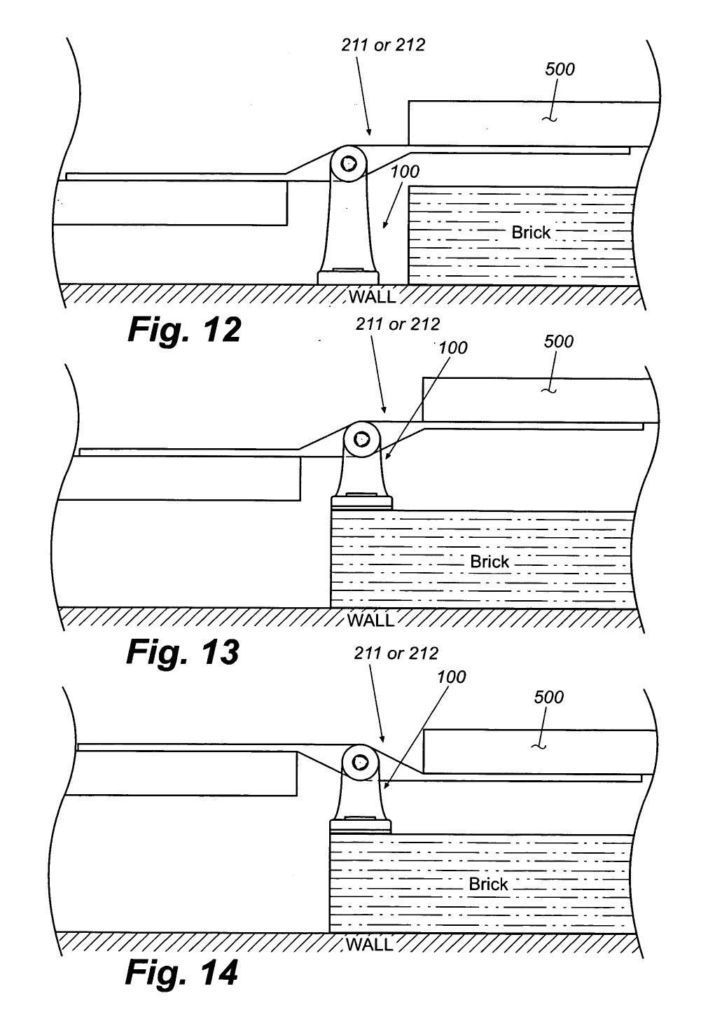

When it is said that the pintel (120) is spaced away from the plate (110), it is meant that the center axis of the pintel is located at some distance from the flat surface (or back) of the base plate (110), as shown in FIGS. 2B and 2C and FIGS. 3B and 3C. The distance from the back of the base plate to the center axis of the pintel is indicated as “S” in FIGS. 2C and 3C. This distance should be the same for any pair of pintel hinges that comprise a hinge assembly, but can be different for pintel hinge pairs according to the type of mounting that is required, as will be discussed below. In preferred embodiments, the pintel is spaced away from the back of the base plate by a distance of 1.75 inches (4.45 cm), or 3 inches (7.62 cm). The distance that the pintel is spaced away from the base plate is generally determined by the length of the arm (115) that extends from the base plate (110). FIGS. 2B and 2C illustrate a pintel hinge having a shorter arm (115) that is suitable for mountings of the type shown in FIGS. 13 and 14, and FIGS. 3B and 3C illustrate a pintel hinge on which the arm (115) is longer and which is suitable for mountings of the type shown in FIG. 12.

The weight-bearing surface (140) of the boss (116) is shown in FIGS. 2C and 3C as a round, flat surface that can be machined onto the boss (116) after the base is formed. However, this surface can have almost any shape and be formed by almost any method, as long as it serves as a weight bearing surface for the socket of an L-hinge when the socket is mated onto the pintel (120). Optionally, a washer (127) can be inserted over the pintel (120) to sit upon the weight-bearing surface (140) and protect it and the end of the socket from wear. The optional washer can be made of a resilient material, and can be nylon or polyethylene, for example.

The base plate (110) of the pintel hinge (100) optionally has holes drilled therethrough for attaching the pintel hinge to a wall. The holes can, if desired, be at the centers of flat surfaces (150 and 150′ of FIGS. 2A and 3A) that can be milled onto the base plate (110). The holes through the base plate (110) are of any size and any location that is suitable for securely attaching the base plate to a vertical wall—such as to the exterior wall of a building.

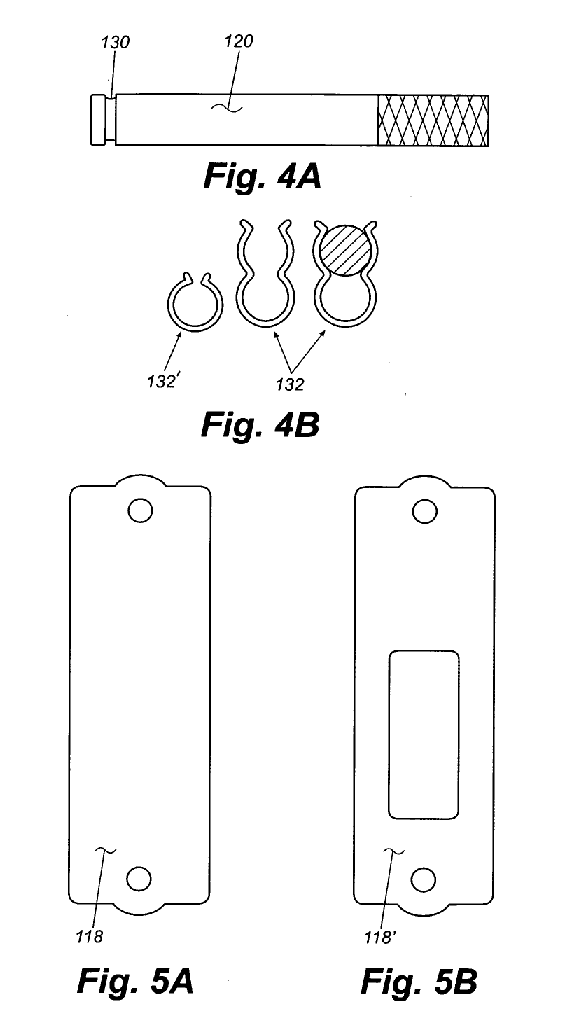

An embodiment of a pintel (120) of the present invention is shown in FIG. 4A. The pintel is typically a cylindrical rod that is formed from one piece of material. The pintel can be of any length and any diameter, but a length of about 2.9 inches (7.3 cm) and a diameter of about 0.3 inches (0.76 cm) are preferred. One end of the pintel (120) can be formed for secure attachment to the boss (116) of the pintel hinge. As shown in FIG. 4A, the cross-hatched section of the pintel (120) can be left plain, or it can be threaded, knurled, checkered, or otherwise finished to enhance a secure fit into the boss (116). Each pintel (120) is affixed to the pintel hinge by press fit, welding, threaded fit, or cast in place.

As mentioned above, a snap-ring groove (130) can be formed into the pintel (120) to receive a snap ring (132′) or hairpin clip (132). A snap ring (132′) and a hairpin clip (132) are illustrated in FIG. 4B. These items are common articles of commerce. Suitable pintels and snap rings or hairpin clips for use with the present hinge assembly are preferably made of a durable and corrosion-resistant metal, such as stainless steel. It has been found that 18/8 stainless steel is more preferred.

FIGS. 5A and 5B illustrate embodiments of a gasket (118 and 118′) that optionally is placed between the base plate (110) and the wall of a building when the pintel hinge (100) is attached to the wall. In FIG. 5A, a gasket (118) is shown that is solid and has no central cut-out. In FIG. 5B, a similar gasket (118′) is shown that has a central cut-out section that roughly matches the footprint of the base plate (110) when the base plate has a hollow section, as indicated in FIGS. 2B and 3B (as is typical when the base is formed by casting). The gasket can be made of any resilient material, but is preferably rubber, more preferably neoprene rubber, and even more preferably UV inhibited black neoprene rubber having a Durometer 60 rating. The gasket can be of almost any reasonable thickness, but it is preferred that gasket is neoprene rubber of a thickness of between about 1 mm and 4 mm, and more preferred that gasket is of a thickness of between about 2 mm and 3 mm.

The gasket can be die-cut to fit the footprint of the base plate (110) and optionally can be secured in place to the flat surface of the base plate (110) prior to installation with double-backed tape or a suitable elastomeric adhesive. It is preferred that the edges of the gasket (118 and 118′) are flush with the edges of the base plate (110) of the pintel hinge (100) prior to installing the pintel hinge on a building.

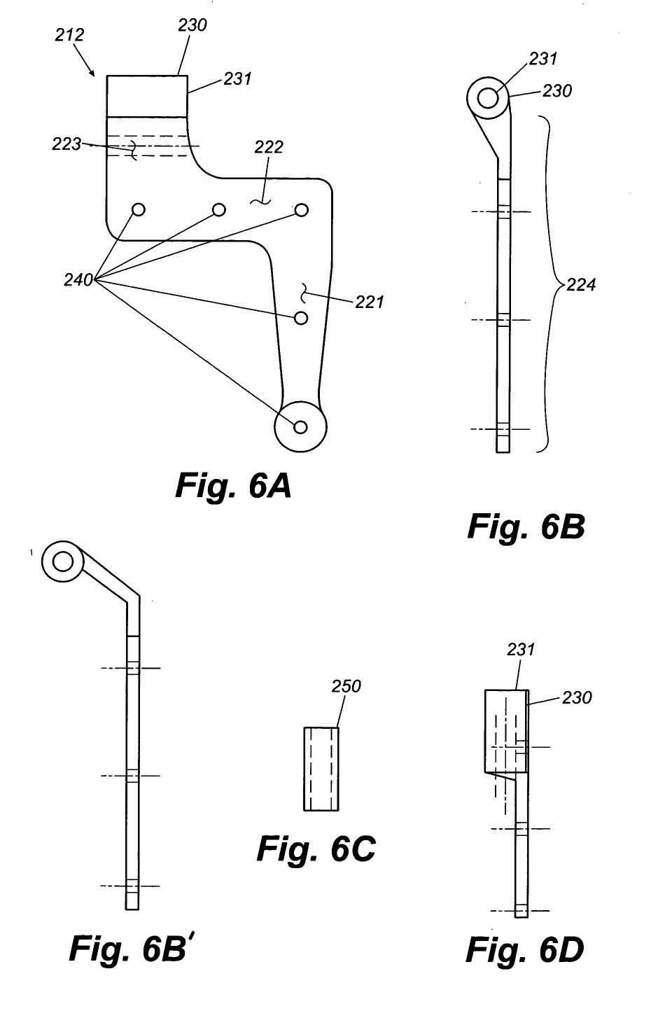

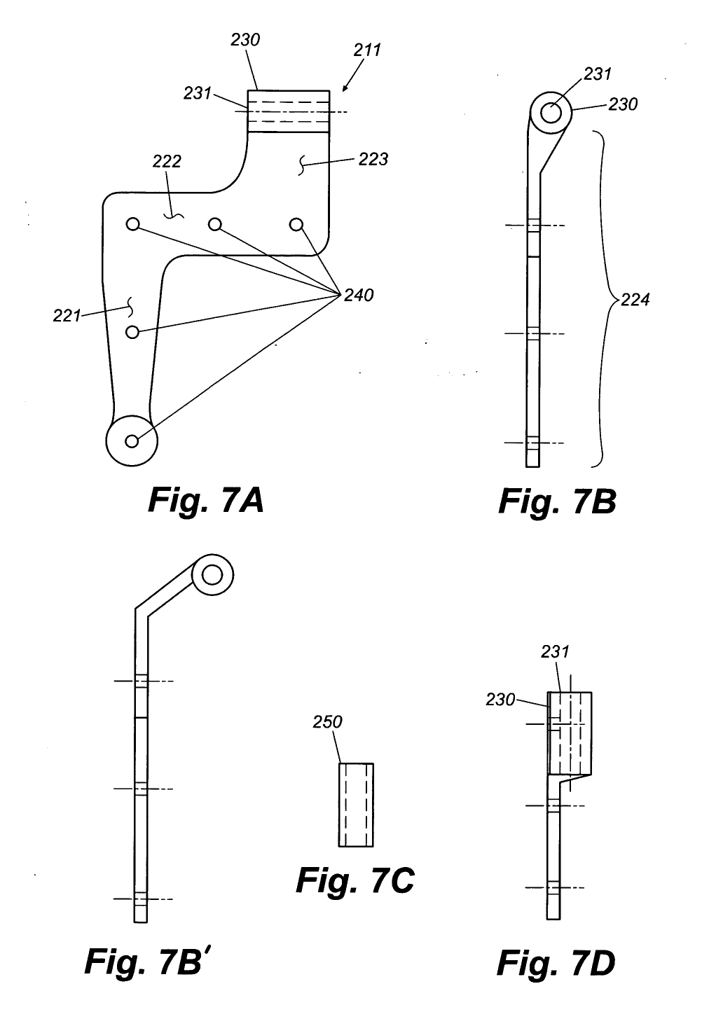

The present hinge assembly includes one or more right-hand L-hinge and one or more left-hand L-hinge. With a shutter of a common household size, it is typical to use two pintel hinges, one right-hand L-hinge and one left-hand L-hinge. The L-hinges of the present invention can be described with reference to FIGS. 6A-6D and FIGS. 7A-7D. As an initial matter, the handedness of an L-hinge is determined as follows: if one grasps the first section (221) of an L-hinge strap (224) in one's hand with the rest of the L-hinge projecting outward between the thumb and forefinger and with the second section (222) of the strap pointed downward (as if shaking hands with the first section of the L-hinge), then the handedness of the L-hinge is determined by noting whether the socket (230) projects to the left or to the right, relative to the holder. If the socket (230) projects to the left, then the L-hinge is a left-hand L-hinge (212), and if the socket (230) projects to the right, then the L-hinge is a right-hand L-hinge (211). An example of a left-hand L-hinge is shown in FIGS. 6A, 6B and 6D, and an example of a right-hand L-hinge is shown in FIGS. 7A, 7B and 7D. In preferred embodiments, left-hand and right-hand L-hinges that are used in a hinge assembly are mirror images of each other.

Again with reference to FIGS. 6A-6D and FIGS. 7A-7D, each L-hinge comprises a socket (230) to mate with a pintel (120) to form a hinged connection and a strap (224) for attachment to a shutter, panel or door (500) that is being mounted.

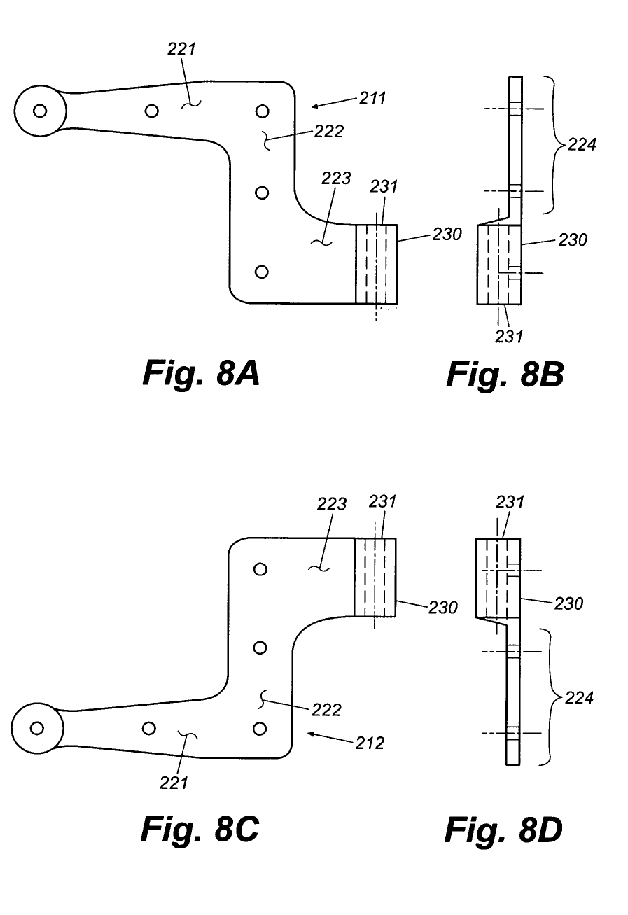

One embodiment of a right-hand L-hinge (211) is shown in FIGS. 7A, 7B and 7D, and includes a strap (224) that comprises a first section (221) joined at one end to an end of a second section (222) at approximately a right angle, and wherein the second section (222) has a third section (223) that extends at approximately a right angle from the second section in a direction opposite the first section and which is connected to the socket (230) so that the center axis of the socket is parallel to the longitudinal axis of the second section. A left-hand L-hinge (212) of this same embodiment is shown in FIGS. 6A, 6B and 6D, and is substantially the mirror image of the right-hand L-hinge described above. A pair of L-hinges that are suitable for use in the present hinge assembly is shown in FIGS. 8A -8D, where a right-hand L-hinge (211) is shown in FIGS. 8A and 8B and a left-hand L-hinge (212) is shown in FIGS. 8C and 8D.

It has been found to be preferred that the first section (221) and the second section (222) of the strap (224) of the right-hand L-hinge (211) are thin relative to their widths (are flat stock), and that the center axis of the socket (230) is offset from the plane of the strap (224) so that one side of the L-hinge will fit flush against a substantially flat surface. This is illustrated, for example, in FIGS. 7B and 7D, and is also shown for a left-hand L-hinge (212) in FIGS. 6B and 6D. The offset of the axis of the socket permits each left-hand and right-hand L-hinge to be used in different configurations for mounting left and right shutters, and for different shutter mounting methods, as illustrated in FIGS. 12-14, as discussed below. In an alternative embodiment, as illustrated in FIGS. 6B′ and 7B′, the amount or degree of the offset of the center axis of the socket can be modified to accommodate the mounting of different types of shutter or different types of mountings.

In a preferred embodiment, the first section (221), second section (222), and third section (223), of the strap (224) of the right-hand L-hinge or the left-hand L-hinge are unitary. That is, all parts of the strap are formed from one piece of metal, such as in a casting, rolling, forging, or stamping process.

In order to attach the L-hinges to the shutter, it is preferred for the first section (221) and the second section (222) of the strap (224) to have holes (240) therethrough for attaching the strap to the shutter. [00050] The socket (230) of each L-hinge is formed to have a bore (231) that runs the length of the socket (230) and is shaped and sized to mate with a pintel (120), thereby forming a hinged attachment between the pintel hinge and the L-hinge. Optionally, the bore (231) can be oversized with respect to the pintel (120) so that a bushing (250, as shown in FIGS. 6C and 7C) can be inserted into the socket so that it fits between the pintel and the socket and provides a replaceable wearing surface between the two parts of the hinge. The bushing can be of any material that is commonly used for such purposes, but is preferably made of a durable polymer such as nylon or polyethylene.

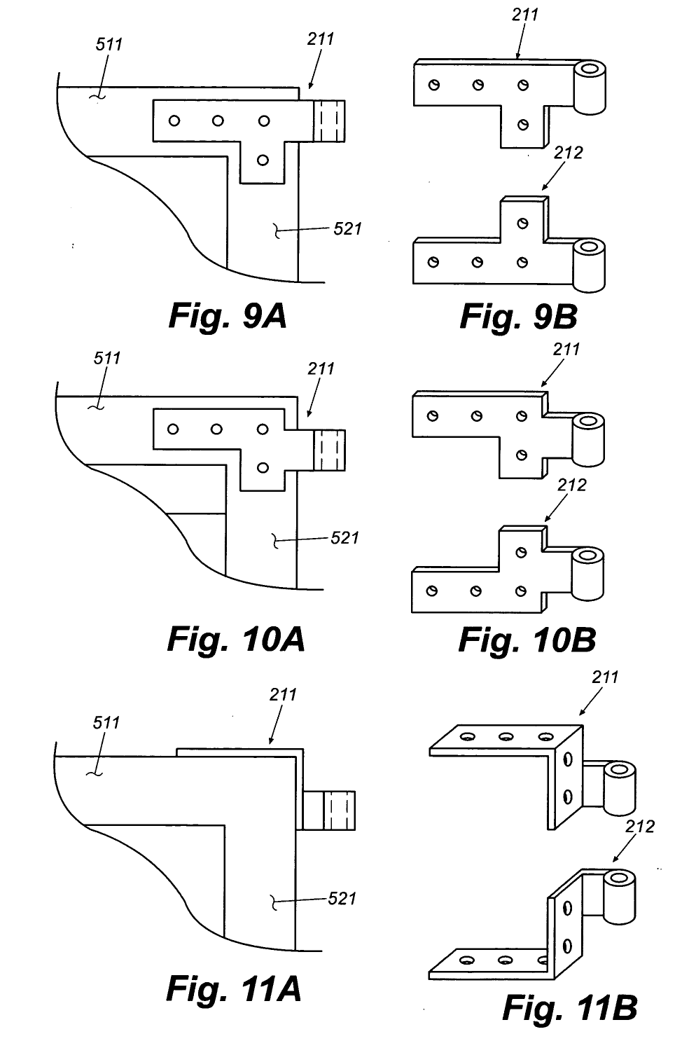

Although the overall shape of the L-hinges that are shown in FIGS. 6, 7 and 8 is a preferred configuration, the L-hinge of the present invention is not limited to that shape. Other L-hinge configurations that are embraced by the present invention include each of those that are shown in FIGS. 9A and 9B, 10A and 10B, and 11A and 11B. It is believed that each of these configurations also provides the advantage given by the angular attachment of the first section and the second section of the strap of the L-hinge, which permits simultaneous attachment of the hinge to both a vertical rail and a horizontal panel of a shutter.

The present L-hinges can be made of any suitable material. It has been found to be preferable, however, that the hinges are made of a metal. Because the present L-hinges contact the pintel hinges, it has also been found to be preferred that the metals from which the two hinge sections are made are not prone to galvanic corrosion. As discussed above, it was found to be preferred that the pintels of the present invention are made of steel, in order to provide suitable strength, but that the bases of the pintel hinges and the L-hinges could be made of an aluminum alloy in order to minimize corrosion. It was found to be preferred that the steel and the aluminum alloy are resistant to environmental corrosion and to galvanic corrosion. In particular, it was found to be preferred that the pintels are made from 18/8 stainless steel and the bases and L-hinges are made from cast LM5 aluminum alloy.

The present hinge assembly can be attached to a shutter (500) having a front and a back, two side rails (521 and 522), a top panel (511) and a bottom panel (512) so that the first section (221) of the strap (224) of each L-hinge (211 and 212) lies along the front of a separate end panel, the second section (222) of the strap of each L-hinge lies along the front of the same side rail, and the third section (223) of the strap and the socket (230) of each L-hinge extend past the side of the rail, where at least two L-hinges are located with the first sections closer to the ends of the shutter and the second sections closer to the center of the shutter and where the substantially flat side of both L-hinges face the same direction—either toward or away from the shutter.

In a mounting design as shown, for example, in FIGS. 12 and 13, the flat side of each L-hinge contacts the front of the shutter. On the other hand, in a mounting design such as shown in FIG. 14, for example, the flat side of each L-hinge does not contact the front of the shutter, but faces away from the shutter.

In a common arrangement in which two shutters are used to cover an opening, such as a window in a building, one shutter is mounted on each side of the window. In this arrangement a first and a second shutter are used, each having a pair of L-hinges mounted thereon, wherein the L-hinges are mounted on the left rail of the first shutter and on the right rail of the second shutter. In order to mount the two shutters on the building, the socket of each L-hinge is mated with the pintel of a pintel hinge, and the base of each pintel hinge is attached to the wall, thereby mounting the shutter on the wall.

The present hinge assembly can be produced by any method, or combination of methods, that is suitable. In general, methods for forming each of the components of the hinge assembly are well known in the trade and are easily determined by one having skill in the art of hinge and shutter production and assembly.

In general, the present hinge assembly is produced by forming two pintel hinges so that each comprises a pintel having an upper end and a lower end, where the lower end is affixed to a base for attachment to the wall, and also by forming one right-hand L-hinge and one left-hand L-hinge, where each L-hinge comprises a socket to mate with a pintel to form a hinged connection and a strap for attachment to the shutter, as those components have been described above. The strap of the right-hand L-hinge is made to include a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section. The left-hand L-hinge is made as a mirror image of the right-hand L-hinge.

In a preferred embodiment, the L-hinges and pintel hinge bases are formed by casting LM5 aluminum alloy, and are finished by applying a powder coating.

In general, the present hinge assembly is used in a manner that is similar to the use of any other shutter-mounting hinge assembly.

In particular, the present hinge assembly can be used to mount a shutter on a vertical wall by providing a shutter having a front and a back, two side rails and a panel at each end, and providing a hinge assembly comprising two pintel hinges each comprising a pintel having a lower end and an upper end, where the lower end is affixed to a base for attachment to the wall, one right-hand L-hinge, and one left-hand L-hinge, and where each L-hinge comprises a socket to mate with a pintel to form a hinged connection and a strap for attachment to the shutter, and wherein the strap of the right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section, and wherein the left-hand L-hinge is a mirror image of the right-hand L-hinge. The two L-hinges are then attached to the shutter so that the first section of each strap lies along the front of a separate end panel, the second section of each strap lies along the front of the same side rail, and the third section of each strap and the socket extend past the side of the rail, where at least two L-hinges are located with their respective first sections closer to the ends of the shutter and the respective second sections closer to the center of the shutter and where the substantially flat side of both L-hinges face the same direction. After the L-hinges have been attached to the shutter, the socket of each L-hinge is mated with the pintel of a pintel hinge, and the base of each pintel hinge is attached to the wall to mount the shutters onto the wall.

The present method can further comprise installing snap rings or hairpin clips on each pintel to retain the sockets of each L-hinge. Also, it can further comprise installing a resilient gasket between the base of each pintel hinge and the wall prior to attaching the pintel hinge to the wall. [00062] All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. In addition it should be understood that aspects of the various embodiments may be interchanged both in whole or in part.

What is claimed is:

1. A hinge assembly for mounting a shutter onto a vertical wall, the assembly comprising:
two or more pintel hinges, each comprising a pintel having an upper end and a lower end, where the lower end is affixed to a base for attachment to the wall;
one or more right-hand L-hinge; and
one or more left-hand L-hinge,
wherein each L-hinge comprises a socket to mate with a pintel to form a hinged connection and a strap for attachment to the shutter, and
wherein the strap of each right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section, and
wherein each left-hand L-hinge is a mirror image of each of the right-hand L-hinges.

2. The hinge assembly according to claim 1, wherein the base comprises a plate having a flat surface to mate with the wall and an arm extending from the plate opposite the flat surface and ending in a boss into which the lower end of the pintel is mounted so that the pintel is spaced away from the plate and is vertical when the plate is attached to the wall, the boss having a horizontal weight bearing surface at the mounted end of the pintel to support the socket of an L-hinge, which, when mated with the pintel, forms a hinged attachment between the pintel hinge and the L-hinge.

3. The hinge assembly according to claim 1, wherein the first section and the second section of the strap of each right-hand L-hinge are thin relative to their widths and the center axis of the socket is offset from the plane of the strap so that one side of the strap of each L-hinge fits substantially flush against a flat surface.

4. The hinge assembly according to claim 3, wherein the first section, second section, and third section of the strap of each right-hand L-hinge are unitary.

5. The hinge assembly according to claim 1, wherein the first section and the second section of each strap have holes therethrough for attaching the strap to the shutter.

6. The hinge assembly according to claim 1, wherein the pintels are steel and the bases and L-hinges are an aluminum alloy.

7. The hinge assembly according to claim 6, wherein the steel and the aluminum alloy are resistant to environmental corrosion and to galvanic corrosion.

8. The hinge assembly according to claim 6, wherein the pintels are 18/8 stainless steel and the bases and L-hinges are cast LM5 aluminum alloy.

9. The hinge assembly according to claim 2, wherein each pintel has a snap-ring groove to accept a snap ring or a hairpin clip, where the groove is located on the pintel near the top end to be above the socket of the L-hinge when the socket is mated with the pintel.

10. The hinge assembly according to claim 9, wherein the groove is fitted with a hairpin clip to retain the socket on the pintel.

11. The hinge assembly according to claim 2, further comprising a resilient gasket between the flat surface of the base and the wall to which each pintel hinge is mounted.

12. The hinge assembly according to claim 11, wherein the resilient gasket is neoprene rubber of a thickness of between about 1 mm and 4 mm.

13. The hinge assembly according to claim 12, wherein the neoprene rubber is of a thickness of between about 2 mm and 3 mm.

14. The hinge assembly according to claim 2, wherein each pintel is affixed to the pintel hinge by press fit, welding, threaded fit, or cast in place.

15. The hinge assembly according to claim 2, having a resilient washer between the horizontal weight bearing surface of each pintel hinge and the socket of the L-hinge to which it is mated.

16. The hinge assembly according to claim 2, having a resilient bushing between each pintel and the socket of the L-hinge to which it is mated.

17. The hinge assembly according to claim 3, wherein the two or more pintel hinges comprise two pintel hinges, and wherein the one or more right-hand L-hinge comprises one right-hand L-hinge and the one or more left-hand L-hinge comprises one left-hand L-hinge.

18. The hinge assembly according to claim 17, wherein the two L-hinges are attached to a shutter having a front and a back, two side rails, a top panel and a bottom panel so that the first section of the strap of each L-hinge lies along the front of a separate end panel, the second section of the strap of each L-hinge lies along the front of the same side rail, and the third section of the strap and the socket of each L-hinge extend past the side of the rail, where the two L-hinges are located with the first sections closer to the ends of the shutter and the second sections closer to the center of the shutter and where the substantially flat side of both L-hinges face the same direction.

19. The hinge assembly according to claim 18, wherein the center line of the socket is offset away from the plane of the shutter.

20. The hinge assembly according to claim 18, wherein the center line of the socket is offset toward the plane of the shutter.

21. The hinge assembly according to claim 18, comprising a first and a second shutter with L-hinges mounted thereon, wherein the L-hinges are mounted on the left rail of the first shutter and on the right rail of the second shutter.

22. The hinge assembly according to claim 21, wherein the socket of each L-hinge is mated with the pintel of a pintel hinge, and wherein the base of each pintel hinge is attached to the wall, thereby mounting the shutter on the wall.

23. A method of producing a hinge assembly for mounting a shutter on a vertical wall, the method comprising:
forming two or more pintel hinges, each comprising a pintel having an upper end and a lower end, where the lower end is affixed to a base for attachment to the wall;
forming one or more right-hand L-hinge; and
forming one or more left-hand L-hinge,
wherein each L-hinge comprises a socket to mate with a pintel to form a hinged connection and a strap for attachment to the shutter, and
wherein the strap of each right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section, and
wherein each left-hand L-hinge is a mirror image of the right-hand L-hinge.

24. The method according to claim 23, wherein the pintel is formed from 18/8 stainless steel and the L-hinge and base are formed by casting LM5 aluminum alloy.

25. The method according to claim 24, wherein the L-hinge and base are finished by applying a powder coating.

26. A method of mounting a shutter on a vertical wall, the method comprising:
providing a shutter having a front and a back, two side rails and a panel at each end;
providing a hinge assembly comprising
two or more pintel hinges each comprising a pintel having a lower end and an upper end, where the lower end is affixed to a base for attachment to the wall;
one or more right-hand L-hinge; and
one or more left-hand L-hinge,
wherein each L-hinge comprises a socket to mate with a pintel to form a hinged connection and a strap for attachment to the shutter, and wherein the strap of the right-hand L-hinge comprises a first section joined at one end to an end of a second section at a right angle, and wherein the second section has a third section that extends at a right angle from the second section in a direction opposite the first section and which is connected to the socket so that the center axis of the socket is parallel to the longitudinal axis of the second section and optionally offset from the plane of the strap, and wherein each left-hand L-hinge is a mirror image of the right-hand L-hinge;
attaching each L-hinge to the shutter so that the first section of each strap lies along the front of a separate end panel, the second section of each strap lies along the front of the same side rail, and the third section of each strap and the socket extend past the side of the rail, where at least two L-hinges are located with their respective first sections closer to the ends of the shutter and the respective second sections closer to the center of the shutter and if the center axis of the socket of one L-hinge is offset from the plane of the shutter, the center axis of the sockets of all L-hinges are offset toward the same side of the shutter;
mating the socket of each L-hinge with the pintel of a pintel hinge; and attaching the base of each pintel hinge to the wall.

27. The method according to claim 26, further comprising installing snap rings of hairpin clips on each pintel to retain the sockets of each L-hinge.

28. The method according to claim 26, further comprising installing a resilient gasket between the base of each pintel hinge and the wall prior to attaching the pintel hinge to the wall.
